(19) United States
(12) Patent Application Publication
(10) Pub. No.: US 2018/0350472 A1
(43) Pub. Date: Dec. 6, 2018

(54) PASSIVE SAFE COOLING SYSTEM

(71) Applicant: China Nuclear Power Technology Research Institute Co., Ltd, Shenzhen (CN)

(72) Inventor: Xiangang Fu, Shenzhen (CN)

(21) Appl. No.: 15/527,906

(22) PCT Filed: Jul. 3, 2015
(86) PCT No.: PCT/CN2015/083238

§ 371 Date: May 18, 2017

(30) Foreign Application Priority Data
Nov. 19, 2014 (CN) 201410664612.0

(51) Int. Cl. G21C 15/18; G21C 9/012

(52) U.S. Cl. CPC G21C 15/18; G21C 9/012

(57) ABSTRACT

A passive safe cooling system includes a water replenishing tank, an advanced safe injection tank, a built-in material replacing water tank, a pressure relief system, a passive emergency water supply system and a passive containment cooling system, the passive emergency water supply system is adapted for hermetically running through the containment and is configured correspondingly to a steam generator in the containment, and the passive containment cooling system is adapted for hermetically running through the containment to remove the heat from the containment. This system can effectively implement safety functions such as nuclear core reactivity control, residual heat removal and containment of radioactive material under a nuclear accident, ensure the reactor core to be effectively cooled down and maintain in a safe shutdown state, improve the safety of the nuclear power plant and greatly reduce the construction costs and operation and maintenance costs.

### FIELD OF THE INVENTION

The invention relates to technical field of safety equipment for reactors in a nuclear power plant, and more particular to a passive safe cooling system that is applicable for concrete containment.

### BACKGROUND OF THE INVENTION

In the existing pressurized water reactor nuclear power plant, containment widely adopts a concrete structure. However, since the concrete with thick wall has poor heat conducting property, thus the heat in the concrete containment can not be removed to the atmosphere by itself after an accident. Therefore, an active residual heat removal system is utilized to achieve residual heat removal for the reactor core in some nuclear power plants. However, such an active system requires external powers in case of overall power failure, for example, expensive emergency diesel generator, emergency water supply system and safe injection system, etc. are required, which greatly increases the amount of equipment, as a result, purchase, installation, operation and maintenance costs for the equipments are reduced, and finally the construction costs and operation and maintenance costs of the nuclear power plant are increased accordingly.

For this reason, passive residual heat removal methods are proposed in the new generation reactors. In one of the methods, steel containment is applied, and a water tank and a spraying system are configured on the top of the steel containment, after a rector accident, a valve of the spraying system is turned on to spray water on the top of the steel containment, thus heat in the containment can be removed by evaporation or convection. By this token, water film formed on the outer wall of the steel containment is critical with respect to the heat exchange capacity; unfortunately, a large-scale and effective water film is difficult to achieve. Furthermore, the existing passive residual heat removal system just conducts the heat to a built-in water tank in the containment, instead of removing the heat outside the containment.

Therefore, it is necessary to provide a passive cooling system stably, reliably and for long removing the heat from the containment and reducing operation and maintenance costs, so as to overcome the drawback mentioned above.

### SUMMARY OF THE INVENTION

One objective of the invention is to provide a passive safe cooling system stably, reliably and for long removing the heat from the containment and reducing operation and maintenance costs.

To achieve the above-mentioned objective, the present invention provides a passive safe cooling system, comprising a water replenishing tank, an advanced safe injection tank, a built-in material replacing water tank, a pressure relief system, a passive emergency water supply system and a passive containment cooling system, the water replenishing tank, the advanced safe injection tank, the built-in material replacing water tank and the pressure relief system being configured in a containment and communicated with a pressure vessel in the containment, wherein the passive emergency water supply system is adapted for hermetically running through the containment and is configured correspondingly to a steam generator in the containment to achieve feedwater reflux and heat removal in the steam generator, and the passive containment cooling system is adapted for hermetically running through the containment to remove the heat from the containment.

Preferably, the water replenishing tank, the advanced safe injection tank, and the built-in material replacing water tank are communicated with the pressure vessel by means of an injection pipeline.

Preferably, the water replenishing tank is located higher than the pressure vessel, one end of the water replenishing tank is communicated with the injection pipeline by means of a first pipeline which is provided with a first valve. When nuclear accidents such as large break accident or other accidents which may reduce the coolants in the primary loop of the reactor occur, the concentrated boron solution in the water replenishing tank will flow through the first pipeline and the injection pipeline in turns and finally inject into the pressure vessel, by virtue of gravity.

Preferably, another end of the water replenishing tank is communicated with a cold pipe section of the pressure vessel by means of a pressure balance pipeline. Under the action of the pressure balance pipeline, the concentrated boron solution in the water replenishing tank by virtue of gravity will flow into the pressure vessel, and the coolants in the cold pipe section will flow through the pressure balance pipeline and then come into the water replenishing tank.

Preferably, the advanced safe injection tank is communicated with the injection pipeline by means of a second pipeline which is provided with a second valve. When loss of coolant accident (LOCA) happens in the primary loop, hydraulics components in the advanced safe injection tank may achieve rapid flooding to the lower cavity of the pressure vessel and the downward section of the reactor core, and maintain the flooding for a longer time.

Preferably, the injection pipeline is provided with a third valve.

Preferably the water advanced safe injection tank has an initial accumulating pressure.

Preferably, the built-in material replacing water tank is located higher than the pressure vessel. In the late stage of the coolant loss accident, pressure of the primary loop is released fully, the built-in material replacing water tank can achieve passive injection for the primary loop due to its location is in a high position.

Preferably the water replenishing tank, the advanced safe injection tank and the built-in material replacing water tank contain Boron solution.

Preferably, the pressure relief system comprises a pressure relief pipeline and a pressure relief valve arranged on the pressure relief pipeline, and the pressure relief pipeline has one end communicated with a pressure regulator in the containment and/or a hot pipe section of the pressure vessel, and the other end communicated with inner space of the containment or the built-in material replacing water tank. When the coolants in the primary loop of the nuclear power plant are reduced to a predetermined level, the pressure relief system can fully reduce the pressure of the primary loop.

Preferably, the passive emergency water supply system comprises a steam pipeline, a water supply pipeline and a steam condenser configured outside the containment, the location of the steam condenser is higher than that of the steam generator in the containment, the steam pipeline is adapted for hermetically running through the containment and connected with an outlet of the steam generator and an inlet of the steam condenser, and the water supply pipeline is adapted for hermetically running through the containment and connected with an outlet of the steam condenser and an inlet of the steam generator. Under the condition of design basis accidents or beyond design basis accidents, the steam in the steam generator passes through the steam pipeline and then reaches to the steam condenser which is condensed into liquid by heat exchange, then the liquid is returned to the steam generator, thereby achieving feedwater reflux and heat removal in the steam generator, so that the heat in the containment can be removed to the ultimate heat sink.

Preferably, the steam condenser is placed in a condensation tank configured outside the containment and is submerged in cooling water of the condensation tank.

Preferably, the steam condenser is placed in an air cooling tower configured outside the containment.

Preferably, the steam pipeline is provided with a fourth valve, and the water supply pipeline is provided with a fifth valve.

Preferably, the passive containment cooling system comprises an internal heat exchanger, an external heat exchanger, an upward pipe, a downward pipe and a cooling medium, the internal heat exchanger is configured in the containment, the external heat exchanger is configured outside the containment and is located higher than the internal heat exchanger, the upward pipe is adapted for hermetically running through the containment and communicated with an outlet of the internal heat exchanger and an inlet of the external heat exchanger respectively, the downward pipe is adapted for hermetically running through the containment and communicated with an outlet of the external heat exchanger and an inlet of the internal heat exchanger respectively, and the cooling medium flows in a circulation channel that is formed by the internal heat exchanger, the upward pipe, the external heat exchanger and the downward pipe. After the accidents, the heat in the containment is passively removed to the outside by means of the cooling medium flowing in the circulation channel, thereby cooling down the containment in the late stage of the accident.

Preferably, the external heat exchanger is placed in a cooling pool that is configured outside the containment.

Preferably, the downward pipe is provided with a sixth valve that is configured outside the containment.

Compared with the prior art, the passive safe cooling system of the present invention has the supplemental water tank, the advance safe injection tank, the built-in material replacing water tank and the pressure relief system that are communicated with the pressure vessel respectively, thus in different stages of the nuclear accident, the supplemental water tank, the advance safe injection tank and the built-in material replacing water tank can automatically inject to the pressure vessel respectively, meanwhile the pressure relief system can automatically reduce the pressure of the primary loop of the reactor. The passive emergency water supply system hermetically runs through the containment and is configured correspondingly to the steam generator, and the system can be automatically started up under the condition of design basis accident or beyond design basis accident, thereby achieving feedwater reflux and heat removal in the steam generator to cool down the reactor to stay in safe shutdown state. The passive containment cooling system hermetically runs through the containment, which includes cooling mediums flowing in the circulation channel thereby removing the residual heat of the containment to the atmosphere stably, reliably and for long, without depending on active equipments. That is, the present invention can effectively implement safety functions such as reactor core reactivity control, residual heat removal and containment of radioactive material under a nuclear accident, and cool down the core for a long time and keep it stay in safe shutdown status to improve the safety of the nuclear power plant, without depending on active systems or operators. As a result, amount of equipments is decreased greatly, thus purchase, installation, operation and maintenance costs for the equipments are reduced, and finally the construction costs and operation and maintenance costs of the nuclear power plant are reduced accordingly.

### BRIEF DESCRIPTION OF THE DRAWINGS

FIG. 1 is a schematic view of a passive safe cooling system according to one embodiment of the invention; and

FIG. 2 is a schematic view of the passive safe cooling system in the operation state.

### DETAILED DESCRIPTION OF ILLUSTRATED EMBODIMENTS

Various preferred embodiments of the invention will now be described with reference to the figures, wherein like reference numerals designate similar parts throughout the various views. The passive safe cooling system 100 provided in the present invention is mainly applicable to PWR nuclear power plant with electric powers of 300 thousand˜2 million kilowatt (electric power) and with concrete containment 200, which is not limited however.

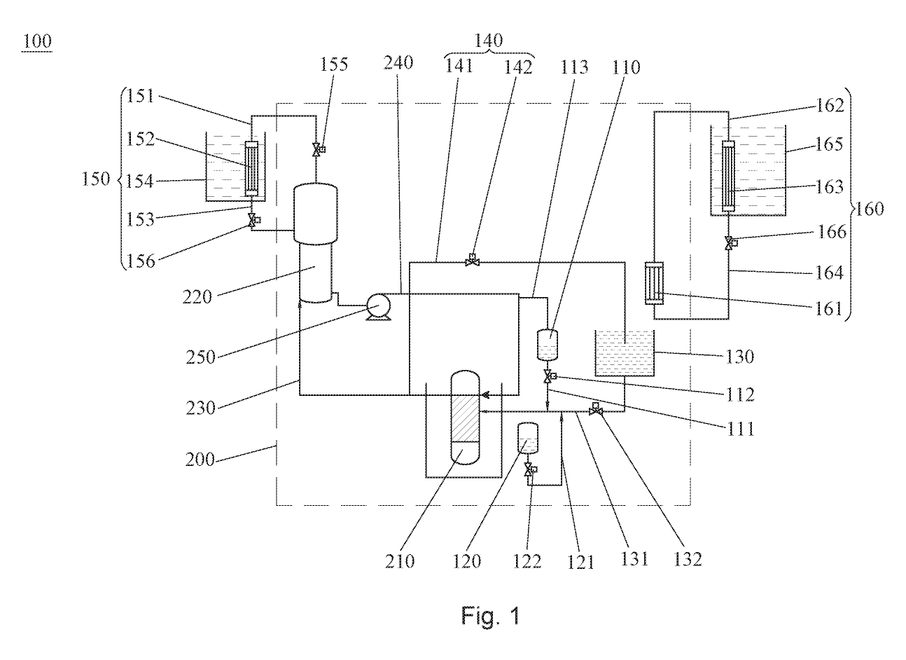

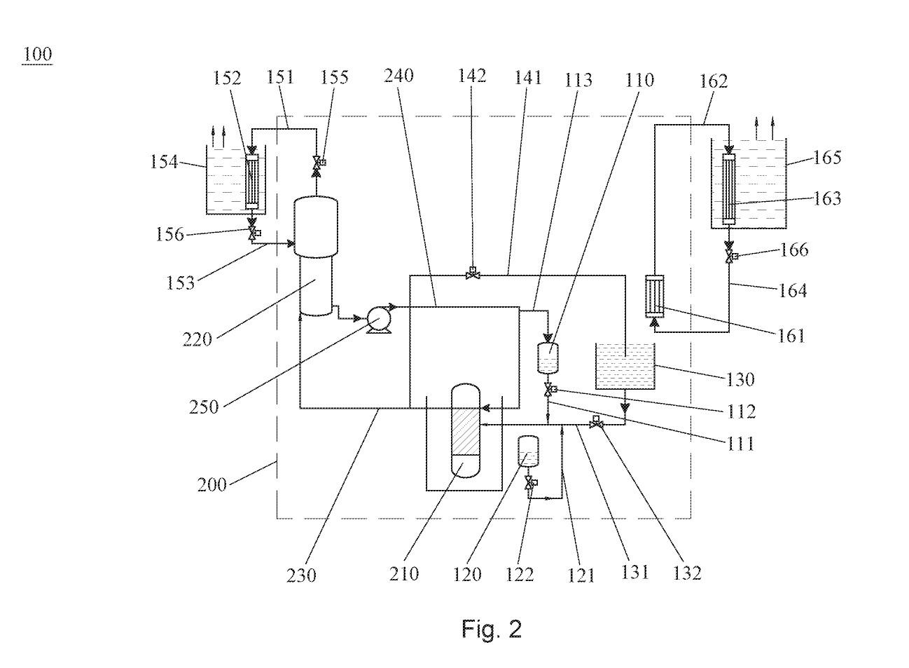

As shown in FIG. 1, the concrete containment 200 is provided with a pressure vessel 210 and a steam generator 220 that are connected by means of pipes, and the pipes include a hot pipe section 230 and a cold pipe section 240, and a primary loop main bump 250 is provided with the cold pipe section 240. The hot pipe section 230, the cold pipe section 240 and the main pump 250 form a loop. A common nuclear power plant has more than one loop, but FIG. 1 and FIG. 2 just show only one, for better illustration. When the nuclear power plant is in normal operation, the coolants will be heated by huge heat energy generated by the reactor core of the primary loop, and then the coolants will pass through the heat pipe section 230 and go into the heat transfer pipe in the steam generator 220, in such a way, the heat energy is transferred to the cooling water in the secondary loop that is located outside the heat transfer pipe, and finally the coolants will be returned to the reactor core through the main pump 250 and the cold pipe section 240.

The passive safe cooling system 100 of the present invention can achieve safety functions such as reaction control of reactor core, residual heat removal and radioactivity substance containment in an accident. The system 100 includes at least one water replenishing tank 110, at least one advance safe injection tank 120, a built-in material replacing water tank 130, a pressure relief system 140, at least one passive emergency water supply system 150 and at least one passive containment cooling system 160. Specifically, the water replenishing tank 110, the advance safe injection tank 120, the built-in material replacing water tank 130 and the pressure relief system 140 are configured in the containment 200 and respectively communicated with the pressure vessel 210 in the containment 200; the passive emergency water supply system 150 hermetically runs through the containment 200 and is configured correspondingly to the steam generator 220, the passive containment cooling system 160 is arranged for achieving feedwater reflux and heat removal in the steam generator, and the passive containment cooling system 160 hermetically runs through the containment 200 to remove the heat from the containment 200.

Specifically, the water replenishing tank 110, the advanced safe injection tank 120 and the built-in material replacing water tank 130 are communicated with the pressure vessel by means of an injection pipeline 131.

By combination of the drawings, the structure for each component of the passive safe cooling system 100 is described as below.

As shown in FIG. 1, the location of the water replenishing tank 110 is higher than the location of the pressure vessel 210, and the lower end of the water replenishing tank 110 is communicated with the injection pipe 131 via a first pipeline 111 which is provided with a first valve 112, the upper end of the water replenishing tank 110 is communicated with the cold pipe section 240 via a pressure balance pipeline 113. The water replenishing tank 110 is contained with concentrated boron solution. Once nuclear accidents such as large break loss of water accident or other accidents which may reduce the coolants in the primary loop of the reactor occur, the first valve 112 will be triggered by the protection signal, then under the action of the pressure balance pipeline 113, the concentrated boron solution in the water replenishing tank 110 by virtue of gravity will flow through the first pipeline 111 and the injection pipeline 131 in turns and finally inject into the pressure vessel 210; and the coolants in the cold pipe section 240 will flow through the pressure balance pipeline 113 and then come into the water replenishing tank 110.

In the present invention, the arrangements of multiple water replenishing tanks 110 are the same, which are not described repeatedly.

Referring to FIG. 1 again, the advanced safe injection tank 120 is communicated with the injection pipeline 131 by means of the second pipeline 121 which is provided with a second valve 122. The advanced safe injection tank 120 is contained with concentrated boron solution and Nitrogen to make it have a certain initial accumulating pressure. When the pressure of the primary loop is reduced to a predetermined level, the second valve 122 will be triggered by the protection signal. Since the advanced safe injection tank 120 has initial accumulating pressure, thus the concentrated boron solution therein will flow through the second pipeline 121 and the injection pipeline 131 and finally inject into the pressure vessel 210, thereby achieving water injection to the reactor core. Comparing with the conventional tank, the advanced safe injection tank 120 of the present invention uses hydraulics components to achieve rapid flooding to the lower cavity of the pressure vessel 210 and the downward section of the reactor core and maintain the flooding for a longer time, once loss of coolant accident occurs in the primary loop.

The installation manners for multiple advanced safe injection tanks 120 are the same, thus are not repeated.

As illustrated in FIG. 1, the location of the built-in material replacing water tank 130 is higher than that of the pressure vessel 210, one end of the injection pipeline 131 is connected to the bottom of the built-in material replacing water tank 130, and the other end of the injection pipeline 131 is communicated with the pressure vessel 210. The injection pipeline 131 is provided with a third valve 132, and the built-in material replacing water tank 130 is contained with concentrated boron solution. In the late stage of the coolant loss accident, pressure of the primary loop is released fully, the built-in material replacing water tank 130 can achieve passive injection for the primary loop due to its location is in a high position.

The pressure relief system 140 includes a pressure relief pipeline 141 and a pressure relief valve 142 arranged on the pressure relief pipeline 141, and the pressure relief pipeline 141 has one end communicated with a pressure regulator in the containment 200 and/or a hot pipe section 230 of the pressure vessel 210, and the other end communicated with inner space of the containment 200 or the built-in material replacing water tank 130.

In the present embodiment, one end of the pressure relief pipeline 141 is communicated with the hot pipe section 230 of the pressure vessel 210, and the other end of the pressure relief pipeline 141 is extended and inserted into the liquid of the built-in material replacing water tank 130. When the coolants in the primary loop of the power nuclear plant are reduced to the predetermined level, the pressure relief valve 142 will be triggered to turn on, so as to make the pressure in the primary loop decrease fully. Further, the pressure relief system 140 may be configured as multiple-step pressure relief.

As shown in FIG. 1, the passive containment cooling system 150 is configured according to the steam generator 220, and multiple passive containment cooling systems 150 can be configured each of which is corresponding with one steam generator 220; additionally a single passive containment cooling system 150 corresponding with multiple steam generators 220 can be configured as well.

In the present embodiment, one passive containment cooling system 150 is corresponding with one steam generator 220. Specifically, the passive containment cooling system 150 includes a steam pipeline 151, a steam condenser 152 and a water supply pipeline 153. The steam condenser 152 is received in the condensation tank 154 that is configured out of the containment 200 and inserted into the coolant liquid in the condensation tank 154. The steam pipeline 151 hermetically runs through the containment 200 and is connected with an outlet of the steam generator 220 and an inlet of the steam condenser 152, and the water supply pipeline 153 is adapted for hermetically running through the containment 200 and connected with an outlet of the steam condenser 152 and an inlet of the steam generator 220.

In addition, the steam pipeline 151 is provided with a fourth valve 155 that is located in the containment 200. The water supply pipeline 153 is provided with a fifth valve 156 which can be located in or outside the containment 200.

Once a large break loss of water accident occurs in the main water supply pipeline, or design basis accidents such as main water supply injection failure occurs or beyond design basis accidents such as in-plant and outside-plant power failure occur (that is, the main pump and the main water supply pump in the primary loop are simultaneously shut down and could not be put into operation for a long time), the passive containment cooling system 150 can start up automatically. Specifically, the fourth valve 155 and the fifth valve 156 are triggered to turn on according to a certain signal, then the steam in the steam generator 220 passes through the steam pipeline 151 and then reaches to the steam condenser 152 which is condensed into liquid by heat exchange, then the liquid is returned to the steam generator 220, thereby achieving feedwater reflux and heat removal in the steam generator 220, so that the heat in the containment 200 can be removed to the ultimate heat sink (namely the atmosphere). Furthermore, in the early stage of the accident, the heat is removed to the atmosphere by means of the cooling water in the condensation tank 154; while in the late stage of the accident, the heat is removed by means of air cooling to cool down the reactor to stay in safe shutdown state,

To be understood, it's not limited that the steam condenser 152 is immerged into the cooling water to cool down, other cooling manners also can be applied, for example, the steam condenser 152 is configured in the air cooling tower that is located outside the containment 200, which is well known to the persons skilled in the art.

Please refer to FIG. 1 again, the passive containment cooling system 160 includes an internal heat exchanger 161, an upward pipe 162, an external heat exchanger 163, a downward pipe 164 and a cooling medium, the internal heat exchanger 161 is configured in the containment 200, the external heat exchanger 163 is configured outside the containment and is located higher than the internal heat exchanger 161, the upward pipe 162 hermetically runs through the containment 200 and is communicated with an outlet of the internal heat exchanger 161 and an inlet of the external heat exchanger 163 respectively, the downward pipe 164 is hermetically runs through the containment 200 and is communicated with an outlet of the external heat exchanger 163 and an inlet of the internal heat exchanger 161 respectively, and the cooling medium flows in a circulation channel that is formed by the internal heat exchanger 161, the upward pipe 162, the external heat exchanger 163 and the downward pipe 164.

Specifically, the inlet of the internal heat exchanger 161 is located at a lower end, and the outlet of the internal heat exchanger 161 is located at an upper end; the external heat exchanger 163 is placed in a cooling pool 165 that is configured outside the containment 200; and the inlet of the external heat exchanger 163 is located at an upper end, and the outlet of the external heat exchanger 163 is located at a lower end. In addition, the downward pipe 164 is provided with a sixth valve 166 that is configured outside the containment 200.

Once a large break loss of water accident or other accidents causing over pressure and over temperature in the containment 200 occur in the nuclear power plant, the passive containment cooling system 160 is started up accordingly and the sixth valve 166 is turned on, then the heat in the containment 200 will be absorbed by the cooling medium in the internal heat exchanger 161, and the heated cooling medium enters into the external heat exchanger 163 to release the heat by condensing, accordingly, the cooling medium after condensing will naturally flow downward due to the increased density, thus the heat in the containment 200 is passively removed to the outside by means of the cooling medium flowing in the circulation channel, thereby cooling down the containment 200 in the late stage of the accident.

Preferably, the cooling medium is cooling water that is kept in a degree of vacuum, and other mediums that can generate phase change in the operation status are also can be applicable.

To be understood, multiple groups of the passive containment cooling systems 160 can be arranged around the containment 200 for improving redundancy and safety.

Combining with FIGS. 1 and 2, working process and principle of the passive safe cooling system 100 are described.

in the normal condition of the nuclear power plant, the passive safe cooling system is available but is not started up.

In the condition of nuclear accidents, the passive safe cooling system 100 is started up according a protection signal. As shown in FIG. 2, once nuclear accidents such as large break loss of water accidents or other accidents which may reduce the coolants in the primary loop of the reactor occur, the first valve 112 will be triggered by the protection signal, then under the action of the pressure balance pipeline 113, the concentrated boron solution in the water replenishing tank 110 by virtue of gravity will flow through the first pipeline 111 and the injection pipeline 131 in turns and finally inject into the pressure vessel 210.

When the pressure of the primary loop is reduced to a predetermined level, the second valve 122 will be triggered by the protection signal. Since the advanced safe injection tank 120 has initial accumulating pressure, thus the concentrated boron solution therein will flow through the second pipeline 121 and the injection pipeline 131 and finally inject into the pressure vessel 210, thereby achieving water injection to the reactor core,

When the coolants in the primary loop of the power nuclear plant are reduced to the predetermined level, the pressure relief valve 142 is triggered according to a signal, so as to make the pressure in the primary loop decrease quickly and fully. Meanwhile, the third valve 132 of the injection pipeline 131 is triggered, thus the concentrated boron solution in the built-in material replacing water tank 130 will flow through the injection pipeline 131 and then inject into the pressure vessel 210 to achieve passive water replenishing to the primary loop.

In the present invention, the passive emergency water supply system 150 may be started up automatically, for whether design basis accidents or beyond design basis accidents. That is, the fourth valve 155 and the fifth valve 156 may be triggered according to a certain signal, then the steam in the steam generator 220 passes through the steam pipeline 151 and then reaches to the steam condenser 152 which is condensed into liquid by heat exchange, then the liquid is returned to the steam generator 220, thereby feedwater reflux and heat removal in the steam generator 220 are achieved, so that the heat in the containment 200 can be removed to the ultimate heat sink (namely the atmosphere). During the steam condenser 152 works, the cooling water in the condensation tank 154 is heated, thus in the early stage of the accident, the heat is removed to the atmosphere by means of the cooling water in the condensation tank 154; while in the late stage of the accident, the heat is removed by means of air cooling to cool down the reactor to stay in safe shutdown state, as illustrated in FIG. 2.

Referring to FIG. 2, once a large break loss of water accident or other accidents causing high pressure and high temperature in the containment 200 Occur in the nuclear power plant, the passive containment cooling system 160 is started up accordingly, the sixth valve 166 is turned on, the heat in the containment 200 will be absorbed by the cooling medium in the internal heat exchanger 161, thus the heated cooling medium flows through the upward pipeline 162 to enter into the external heat exchanger 163 to release the heat by condensing, accordingly, the cooling medium after condensing will naturally flow downward due to the increased density, thus the heat in the containment 200 is passively removed to the outside by means of the cooling medium flowing in the circulation channel, thereby cooling down the containment 200 in the late stage of the accident.

Compared with the prior art, the passive safe cooling system 100 of the present invention has the water replenishing tank 110, the advance safe injection tank 120, the built-in material replacing water tank 130 and the pressure relief system 140 that are communicated with the pressure vessel 210 respectively, thus in different stages of the nuclear accident, the water replenishing tank 110, the advance safe injection tank 120 and the built-in material replacing water tank 130 can automatically inject to the pressure vessel 210 respectively; meanwhile the pressure relief system 140 can automatically reduce the pressure of the primary loop of the reactor. The passive emergency water supply system 150 hermetically runs through the containment 200 and is configured correspondingly to the steam generator 220, and the system 150 can be automatically started up under the condition of design basis accident or beyond design basis accident, thereby achieving feedwater reflux and heat removal in the steam generator to cool down the reactor to stay in safe shutdown state. The passive containment cooling system 160 hermetically runs through the containment 200, which includes cooling mediums flowing in the circulation channel thereby removing the residual heat of the containment 200 to the atmosphere stably, reliably and for long, without depending on active equipments. That is, the present invention can effectively implement safety functions such as core reactivity control, residual heat removal and containment of radioactive material under a nuclear accident, and cool down the core for a long time and maintain it stay in safe shutdown state to improve the safety of the nuclear power plant, without depending on active systems or operators. As a result, amount of equipments is decreased greatly, thus purchase, installation, operation and maintenance costs for the equipments are reduced, and finally the construction costs and operation and maintenance costs of the nuclear power plant are reduced accordingly.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A passive safe cooling system, comprising a water replenishing tank, an advanced safe injection tank, a built-in material replacing water tank, a pressure relief system, a passive emergency water supply system and a passive containment cooling system, the water replenishing tank, the advanced safe injection tank, the built-in material replacing water tank and the pressure relief system being configured in a containment and communicated with a pressure vessel in the containment, wherein the passive emergency water supply system is adapted for hermetically running through the containment and is configured correspondingly to a steam generator in the containment to achieve feedwater reflux and heat removal in the steam generator, and the passive containment cooling system is adapted for hermetically running through the containment to remove the heat from the containment.

2. The passive safe cooling system according to claim 1, wherein the water replenishing tank, the advanced safe injection tank, and the built-in material replacing water tank are communicated with the pressure vessel by means of an injection pipeline.

3. The passive safe cooling system according to claim 2, wherein the water replenishing tank is located higher than the pressure vessel, one end of the water replenishing tank is communicated with the injection pipeline by means of a first pipeline which is provided with a first valve.

4. The passive safe cooling system according to claim 3, wherein another end of the water replenishing tank is communicated with a cold pipe section of the pressure vessel by means of a pressure balance pipeline.

5. The passive safe cooling system according to claim 2, wherein the advanced safe injection tank is communicated with the injection pipeline by means of a second pipeline which is provided with a second valve.

6. The passive safe cooling system according to claim 2, wherein the injection pipeline is provided with a third valve.

7. The passive safe cooling system according to claim 1, wherein the water advanced safe injection tank has an initial accumulating pressure.

8. The passive safe cooling system according to claim 1, wherein the built-in material replacing water tank is located higher than the pressure vessel.

9. The passive safe cooling system according to claim 1, wherein the water replenishing tank, the advanced safe injection tank and the built-in material replacing water tank contain Boron solution.

10. The passive safe cooling system according to claim 1, wherein the pressure relief system comprises a pressure relief pipeline and a pressure relief valve arranged on the pressure relief pipeline, and the pressure relief pipeline has one end communicated with a pressure regulator in the containment and/or a hot pipe section of the pressure vessel, and the other end communicated with inner space of the containment or the built-in material replacing water tank.

11. The passive safe cooling system according to claim 1, wherein the passive emergency water supply system comprises a steam pipeline, a water supply pipeline and a steam condenser configured outside the containment, the location of the steam condenser is higher than that of the steam generator in the containment, the steam pipeline is adapted for hermetically running through the containment and connected with an outlet of the steam generator and an inlet of the steam condenser, and the water supply pipeline is adapted for hermetically running through the containment and connected with an outlet of the steam condenser and an inlet of the steam generator.

12. The passive safe cooling system according to claim 11, wherein the steam condenser is placed in a condensation tank configured outside the containment and is submerged in cooling water of the condensation tank.

13. The passive safe cooling system according to claim 11, wherein the steam condenser is placed in an air cooling tower configured outside the containment.

14. The passive safe cooling system according to claim 11, wherein the steam pipeline is provided with a fourth valve, and the water supply pipeline is provided with a fifth valve.

15. The passive safe cooling system according to claim 1, wherein the passive containment cooling system comprises an internal heat exchanger, an external heat exchanger, an upward pipe, a downward pipe and a cooling medium, the internal heat exchanger is configured in the containment, the external heat exchanger is configured outside the containment and is located higher than the internal heat exchanger, the upward pipe is adapted for hermetically running through the containment and communicated with an outlet of the internal heat exchanger and an inlet of the external heat exchanger respectively, the downward pipe is adapted for hermetically running through the containment and communicated with an outlet of the external heat exchanger and an inlet of the internal heat exchanger respectively, and the cooling medium flows in a circulation channel that is limited by the internal heat exchanger, the upward pipe, the external heat exchanger and the downward pipe.

16. The passive safe cooling system according to claim 15, wherein the external heat exchanger is placed in a cooling pool that is configured outside the containment.

17. The passive safe cooling system according to claim 15, wherein the downward pipe is provided with a sixth valve that is configured outside the containment.
